(19) United States
(12) Patent Application Publication
(10) Pub. No.: US 2021/0133277 A1
(43) Pub. Date: May 6, 2021

(54) APPARATUS, METHOD, AND PROGRAM FOR SELECTING EXPLANATORY VARIABLES

(71) Applicant: MIZUHO-DL FINANCIAL TECHNOLOGY CO., LTD., Chiyoda-ku, Tokyo (JP)

(72) Inventors: Yasushi TAKANO, Tokyo, Chiyoda-ku (JP); Tatsuro ISHIJIMA, Chiyoda-ku, Tokyo (JP); Kazuyoshi YOSHINO, Chiyoda-ku, Tokyo (JP); Shunsuke AKITA, Chiyoda-ku, Tokyo (JP)

(73) Assignee: MIZUHO-DL FINANCIAL TECHNOLOGY CO., LTD., Chiyoda-ku, Tokyo (JP)

(21) Appl. No.: 16/473,743

(22) PCT Filed: Dec. 27, 2017
(86) PCT No.: PCT/JP2017/046865

§ 371 Date: Jun. 26, 2019

(30) Foreign Application Priority Data
Dec. 28, 2016 (JP) 2016-256233

(51) Int. Cl. G06F 17/18; G06Q 10/04

(52) U.S. Cl. CPC G06F 17/18; G06Q 10/04

(57) ABSTRACT

An apparatus selects variables from a plurality of variables in a model that expresses a relationship between a linear predictor and an expectation value of a response variable or a probability of the response variable having certain values, by using a variable selecting model that expresses the linear predictor as a sum of a constant and a linear combination of the candidate explanatory variables and their corresponding coefficients, the apparatus including a constraint acquisition unit for acquiring a constraint that defines a set of possible values for each of the coefficients; an estimation unit for calculating an estimate of the respective coefficients and an estimate of the constant under the constraint, using plural data; and a selection unit for selecting, as the desired explanatory variable, the candidate explanatory variable corresponding to the coefficient of which the estimate is calculated to be non-zero.

### TECHNICAL FIELD

The present invention relates to an apparatus, methoxd, and program for selecting explanatory variables.

### BACKGROUND ART

Using statistical models, various phenomena, such as a natural phenomenon or a social phenomenon, have been explained and predicted. An example of the statistical model is given by:

$$\{ \begin{matrix}Z = α + {β}_{1} {x}_{1} + {β}_{2} {x}_{2} + ⋯ & ( 1 ) \\ F ( E [ Y ] ) = Z & ( 2 )\end{matrix}$$

where x₁, x₂, . . . represent variables called “explanatory variables”; β₁, β₂, . . . are coefficients respectively corresponding to explanatory variables x₁, x₂, . . . ; and α is a constant.

In equation (1), Z, defined by the sum of the constant α and a linear combination of explanatory variables and coefficients, is called a linear predictor; and Y is a variable called a response variable. As understood from equation (2), function F defines a relationship between linear predictor Z and expectation value E[Y] of the response variable Y. In this context, function F is not always given by a simple equation, and sometimes is expressed by a composite of plural functions or by a function to be solved numerically because it cannot be given in an analytic form.

For example, the weight is a response variable and the height and waist size can serve as explanatory variables.

One such statistical model is a generalized linear model. Examples of the generalized linear model include a linear regression model, a binomial logit model, and an ordered logit model.

The above statistical models have difficulty in selecting appropriate indicators as explanatory variables. As is known, this becomes an issue of concern in variable selection itself. The variable selection greatly affects the precision and usability of the statistical model.

So-called “brute-force regression” is one approach to select appropriate explanatory variables. With this approach, all possible sets of candidate explanatory variables are examined to find an optimum one. Here, p candidate explanatory variables will offer (2^{p}−1) sets in total. Testing all possible sets, this approach can provide really the best set of variables but imposes a very large computational load. If the number of candidate variables p is large, the number of possible sets explosively increases, making the calculation virtually impractical.

Stepwise regression is another approach to the variable selection. With this approach, explanatory variables are sequentially added to or subtracted from a model based on some criterion such as an F value used in regression analysis, so as to find a more descriptive set of variables. This approach requires a relatively low computational load, and thus, can target many candidate variables. It, however, cannot always give an optimum set of explanatory variables.

In addition, Non-Patent Literature 1 discloses variable selection called “Lasso regression”. Non-Patent Literature 2 discloses variable selection called “elastic-net”. Either one uses a function given by adding a coefficient-dependent penalty term to a likelihood function, so as to select as explanatory variables the variable corresponding to each of the coefficients which has a non-zero value when the function becomes maximum. According to these, the selection of explanatory variables depends on a parameter called a hyperparameter, which regulates a penalty, but the parameter concerned can be selected freely. In addition, a set of selected explanatory variables generally is not meant to maximize the likelihood function itself.

### REFERENCE LIST

### Non-Patent Literature

Non-Patent Literature 1: R. Tibshirani, “Regression shrinkage and selection via the lasso”, A retrospective, Journal of the Royal Statistical Society B, 73, 273-282, 2011

Non-Patent Literature 2: Hui Zou and Trevor Hastie, “Regularization and Variable Selection via the Elastic Net”, Journal of the Royal Statistical Society, Series B: 301-320, 2005

### SUMMARY OF INVENTION

### Technical Problem

The present invention has been made in view of the above background art and it is accordingly an object of the invention to efficiently select explanatory variables from even a relatively large number of candidate explanatory variables.

### Solution to Problem

In order to achieve the above object, the present invention provides an apparatus for selecting desired explanatory variables from a plurality of candidate explanatory variables in a statistical model that expresses, by a predetermined function, a relationship between a linear predictor and an expectation value of a response variable or a probability of the response variable having certain values, by using a variable selecting model that expresses the linear predictor as a sum of a constant and the linear combination of the candidate explanatory variables and their corresponding coefficients. The apparatus comprises a constraint acquisition unit for acquiring a constraint that defines a set of possible values for each of the coefficients, the set of possible values for at least one of the coefficients including zero as an isolated point and also including an element other than zero; an estimation unit for calculating an estimate of the respective coefficients and an estimate of the constant under the constraint, using a plurality of data inclusive of realizations of the respective candidate explanatory variables and realizations of the response variable; and a selection unit for selecting, as the desired explanatory variables, the candidate explanatory variables corresponding to each of the coefficient of which the estimate is calculated to be non-zero.

The present invention also provides an apparatus for selecting desired explanatory variables from a plurality of candidate explanatory variables in a statistical model that expresses, by a predetermined function, a relationship between a plurality of linear predictors and an expectation value of a response variable or probability of the response variable having certain values, by using a variable selecting model that expresses at least one of the linear predictors as a sum of a constant and the linear combination of the candidate explanatory variables and their corresponding coefficients. The apparatus comprises a constraint acquisition unit for acquiring a constraint that defines a set of possible values for each of the coefficients, the set of possible values for at least one of the coefficients including zero as an isolated point and also including an element other than zero; an estimation unit for calculating an estimate of the respective coefficients and an estimate of the constant under the constraint, using a plurality of data inclusive of realizations of the respective candidate explanatory variables and realizations of the response variable; and a selection unit for selecting, as the desired explanatory variable, the candidate explanatory variables corresponding to each of the coefficient of which the estimate is calculated to be non-zero.

### Advantageous Effects of Invention

According to the present invention, explanatory variables can be efficiently selected even from a relatively large number of candidate explanatory variables.

### BRIEF DESCRIPTION OF DRAWINGS

FIG. 1 is an explanatory view showing a functional configuration example of a variable selecting apparatus;

FIG. 2 is an explanatory view of a hardware configuration example of the variable selecting apparatus.

FIG. 3 is a flowchart of a procedure example executed by the variable selecting apparatus.

FIG. 4 is a conceptual diagram of how a coefficient is determined in selecting variables.

FIG. 5 is another conceptual diagram of how a coefficient is determined in selecting variables.

FIG. 6 is a flowchart of another procedure example executed by the variable selecting apparatus.

FIG. 7 is a flowchart of still another procedure example executed by the variable selecting apparatus.

FIG. 8 is still another conceptual diagram of how a coefficient is determined in selecting variables.

FIG. 9 is an explanatory view showing another functional configuration example of the variable selecting apparatus.

### DESCRIPTION OF EMBODIMENTS

As explained above, the selection of explanatory variables faces a problem that numerous potential explanatory variables will lead to a huge number of possible sets of variables. The inventors of the present invention have made extensive studies on this and other problematic issues.

In selecting explanatory variables, it is also necessary to consider the sign of a coefficient corresponding to an explanatory variable. Suppose a statistical model that holds “expectation value of weight=α+β₁×height+β₂×waist size”, for example. As a general assumption, a taller man weighs more. Thus, if the height is selected as an explanatory variable, then coefficient β₁ is expected to be positive. Likewise, it is thought that a man with a larger waste weighs more. Then, if the waist size is selected as an explanatory variable, coefficient β₂ is expected to be positive. In this regard, β₂ of negative value will give a contradictory suggestion that “a man with a larger waist is lighter than someone who has the same height but a smaller waist”. Such a model is really difficult to use.

As exemplified in the previous paragraph, the condition that “each coefficient in a statistical model should have the same sign expected from the relationship between a single explanatory variable and a response variable”, is called a “sign condition” (sign restriction). An estimate of a coefficient in the statistical model is influenced by correlation between explanatory variables, etc. Thus, the statistical model using plural explanatory variables may not necessarily satisfy the sign conditions. Generally speaking, as the number of explanatory variables increases, the difficulty in producing a statistical model that can satisfy the sign conditions increases.

Note that the height and waist size correspond to explanatory variables x₁ and x₂, respectively, in equation (1) and the weight corresponds to the response variable Y in equation (2). Also, function F in equation (2) is an identity function, i.e., F (E[Y])=E[Y]=Z.

In some cases, various demands are added in selecting explanatory variables, such as “making sure a specific candidate explanatory variable can be necessarily selected as an explanatory variable” and “making sure an influence of a specific explanatory variable does not become too high.” A kind of flexibility, as can meet such demands, is required for the variable selection.

Taking into account the above studies, embodiments of the present invention are described below. Note that the present invention is not limited to the following embodiments.

### First Embodiment

This embodiment introduces a statistical model for evaluating a likelihood of a default, i.e., debt default of a certain business or person. A business or person, evaluated as being less likely to default, can be more reliable. Such a statistical model is referred to as a credit-evaluating model.

Many credit evaluating models for businesses use as explanatory variables financial indicators derived from a balance sheet and a profit-and-loss statement. Conceivable examples of the financial indicator include a capital ratio; years of debt redemption, a current account, and accounts receivable turnover period.

In addition, many credit-evaluating models for individuals use as explanatory variables indicators of personal attributes. Conceivable examples of such information include age, number of household members, income, and years of employment.

In either case, it is necessary to precisely assess a borrower's credit prior to judgements on a loan and loan interest. For that purpose, a high-precision credit-evaluating model is eagerly anticipated.

The credit-evaluating model is given by:

$$\{ \begin{matrix}Z = α + {β}_{1} {x}_{1} + {β}_{2} {x}_{2} + ⋯ & ( 3 ) \\ F [ Pr \{ \tilde{D} = 1 \} ] = log ( \frac{Pr \{ \tilde{D} = 1 \}}{1 - Pr \{ \tilde{D} = 1 \}} ) = Z & ( 4 )\end{matrix}$$

where xₖ (k=1, 2, . . .) is an explanatory variable; βₖ is a coefficient corresponding to explanatory variable xₖ; α is a constant; and Z is a linear predictor.

A response variable

\tilde{D}
is a default flag, which is a variable equal to 1 for defaulting on a debt within one year from settlement of accounts, or otherwise 0.

Pr{\tilde{D}=1}

indicates the probability of the default flag being 1.

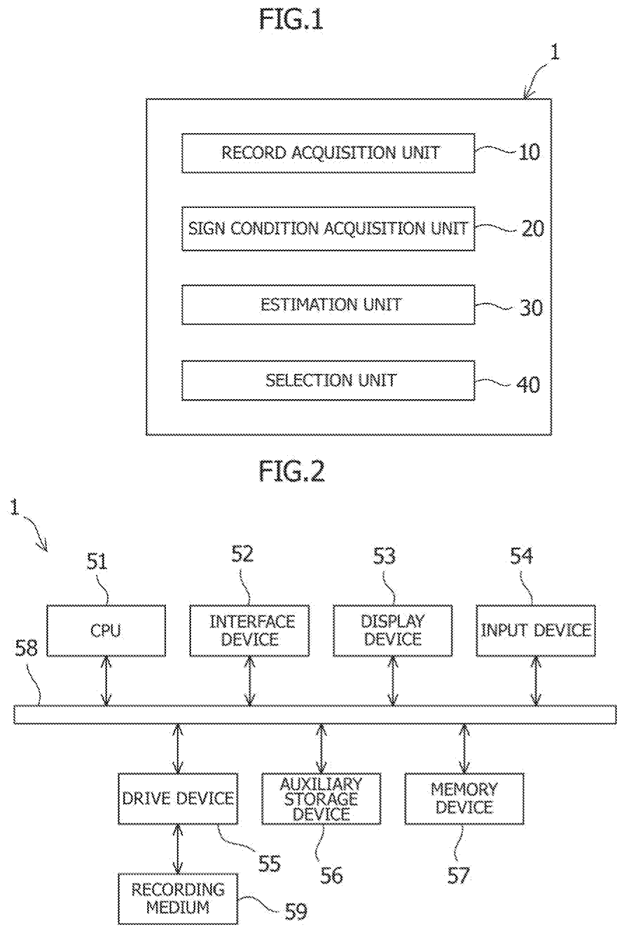

FIG. 1 shows a functional configuration example of a variable selecting apparatus 1 for selecting explanatory variables in a credit-evaluating model. The variable selecting apparatus 1 includes a record acquisition unit 10, a sign condition acquisition unit 20, an estimation unit 30, and a selection unit 40. The respective functional units are detailed later.

FIG. 2 shows an example of the configuration of computer hardware of the variable selecting apparatus 1. The variable selecting apparatus 1 includes a CPU 51, an interface device 52, a display device 53, an input device 54, a drive device 55, an auxiliary storage device 56, and a memory device 57, which are mutually connected via bus 58.

A program for executing functions of the variable selecting apparatus 1 is provided recorded on a recording medium 59 such as a CD-ROM. When the recording medium 59 with the recorded program is inserted into the drive device 55, the program is installed from the recording medium 59 via the drive device 55 to the auxiliary storage device 56. Alternatively, the program can be downloaded via a network from another computer instead of being installed from the recording medium 59. The auxiliary storage device 56 stores the installed program as well as a necessary file, data, etc.

If instructed to start the program, the memory device 57 reads and stores the program from the auxiliary storage device 56. The CPU 51 executes the functions of the variable selecting apparatus 1 according to the program stored in the memory device 57. The interface device 52 serves as an interface with another computer via a network. The display device 53 displays a GUI (Graphical User Interface) created by the program, for example. The display device 54 is a keyboard, a mouse, or the like.

Table 1 shows plural records used upon variable selection in a credit-evaluating model for businesses. The records are stored in the auxiliary storage device 56. The records are also referred to as data.

TABLE 1
Model Building Data

| | | | | Financial Indicator (Candidate Explanatory Variable) | | | | | |
|---|---|---|---|---|---|---|---|---|---|
| | | | | | | | | Ratio of | |
| | | | | | | Years of | | Interest | |
| Business Attributes | | | | Logarithm | Capital | Debt | Current | Burden | |
| Business | Business | Business | Default | of Sales | Ratio | Redemption | Ratio | to Sales | |
| ID | Name | Type | Flag | (k = 1) | (k = 2) | (k = 3) | (k = 4) | (k = 5) | . . . |
| 1 | Business A | Construction | 0 | 9.016 | 46.82% | 6.43 | 129.95% | 1.29% | . . . |
| 2 | Business B | Manufacturer | 0 | 8.669 | 38.71% | 4.73 | 148.03% | 2.88% | . . . |
| 3 | Business C | Retailer | 1 | 9.474 | 19.86% | 16.82 | 101.74% | 4.51% | . . . |
| 4 | Business D | Supplier | 0 | 10.318 | 64.93% | 2.11 | 211.30% | 0.47% | . . . |
| . | . | . | . | . | . | . | . | . | . . . |
| . | . | . | . | . | . | . | . | . | |
| . | . | . | . | . | . | . | . | . | |

In this table, each record shows information about a certain business. The “default flag” is, as discussed above, a variable equal to 1 for defaulting on a debt within one year from settlement of accounts, or otherwise 0. The default flag is a response variable in the credit evaluating model.

Likewise, the “financial indicator” in Table 1 is calculated from business's accounting information in a balance sheet, a profit-and-loss statement, etc. For example, “logarithm of sales” is a logarithmic transformation of sales calculated from the accounting information. The “capital ratio”, “years of debt redemption”, “current ratio”, and “ratio of interest burden to sales” are calculated from the accounting information. These indicators are candidate explanatory variables in the credit-evaluating model. Here, “k” indicates the number assigned to every candidate explanatory variable.

For example, the “capital ratio” of a “business A” with the business ID of “1” is “46.82%”. This value is called a realization for the candidate explanatory variable “capital ratio”. A realization of the response variable “default flag” is “0”. As above, Table 1 includes plural records each containing realizations of plural candidate explanatory variables and that of the response variable.

Of course, the number of candidate explanatory variables is not limited as long as multiple variables are provided. In evaluating the credit of a business, a highly descriptive set of variables is selected from among numerous candidate explanatory variables (financial indicators) so as to evaluate its financial status from many aspects. In general, several tens to over a hundred candidate explanatory variables are prepared. As with the “logarithm of sales” in Table 1, a financial indicator subject to any transformation such as logarithmic transformation or discretization, can be used as a candidate explanatory variable.

A variable selecting model, which the variable selecting apparatus 1 uses in selecting a variable, is given by:

$$\{ \begin{matrix}Z = α + {β}_{1} {X}_{1} + {β}_{2} {X}_{2} + ⋯ & ( 5 ) \\ PD = \frac{1}{1 + exp ( Z )} & ( 6 )\end{matrix}$$

where Xₖ (k=1, 2, . . .) is a candidate explanatory variable; α is a constant; βₖ is a coefficient of candidate explanatory variable Xₖ; Z is a linear predictor; and PD is the probability of the response variable, or the default flag, is equal to “1”.

PD is also referred to as the probability of default.

As mentioned above, the variable selecting model is a statistical model that defines a linear predictor by the sum of the constant and linear combination of plural candidate explanatory variables and their corresponding coefficients.

Here, linear predictor Z in equation (6) has a positive sign, whereby the relationship of “the more the value of Z, the higher the credit” holds. Needless to say, “Z” in equation (6) could be “−Z” such that function F is the distribution function of logistic distribution.

Next, the relationship between an estimate of the probability of default and realizations of candidate explanatory variables in the variable selecting model, is defined by:

$$\{ \begin{matrix}{Z}_{i} = α + {β}_{1} {X}_{i , 1} + {β}_{2} {X}_{i , 2} + ⋯ & ( 7 ) \\ {PD}_{i} = \frac{1}{1 + exp ( {Z}_{i} )} & ( 8 )\end{matrix}$$

where i represents the business ID in Table 1; X_{i,k} is a realization of candidate explanatory variable Xₖ for the business i; Zᵢ is a score of the business i; and PDᵢ is an estimate of the probability of default for the business i in the variable selecting model.

Also, constant α and coefficient βₖ are collectively called parameters, and a parameter vector is indicated by θ.

This yields

θ=(α, β₁, β₂, . . .) (9)

Table 2 shows sign conditions of the respective coefficients used by the variable selecting apparatus 1. The sign condition is a set for each coefficient and defines every possible value of each coefficient as 0 or more, or 0 or less. The sign conditions are stored in the auxiliary storage device 56.

TABLE 2
Sign Condition

| Coefficient | Sign Condition |
|---|---|
| β₁ | 0 or more |
| β₂ | 0 or more |
| β₃ | 0 or less |
| β₄ | 0 or more |
| β₅ | 0 or less |
| . . . | . . . |

The sign condition of “0 or more” is a set for a candidate explanatory variable that will show higher credit when it is large, While “0 or less” is a set for a candidate explanatory variable that will show higher credit when it is small. In this embodiment, the sales (k=1), the capital ratio (k=2), and the current ratio (k=4) will show higher credit when they are large. Thus, coefficients β₁, β₂, and β₄ are given the sign condition of “0 or more”. In contrast, the years of debt redemption (k=3) and the ratio of interest burden to sales (k=5) will show higher credit when they are small. Thus, coefficients β₃ and β₅ are given the sign condition of “0 or less”.

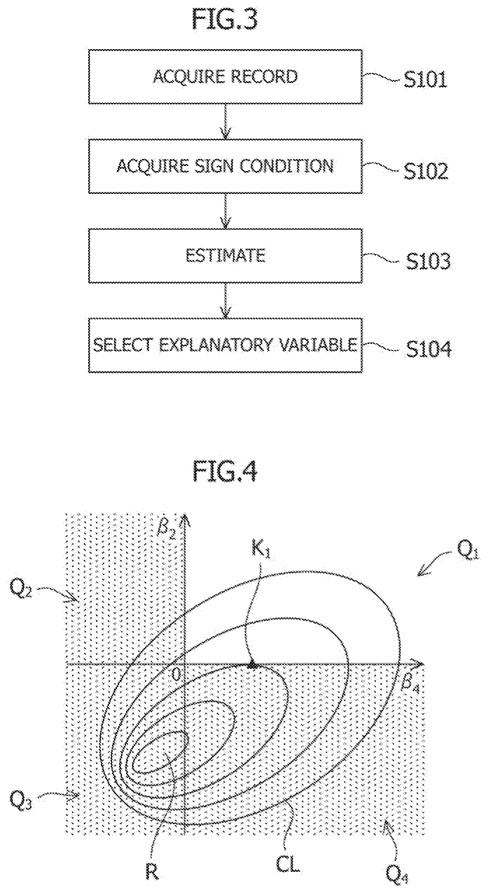

Referring to FIG. 3, a processing flow of the variable selecting apparatus 1 is explained next. First in step S101, the record acquisition unit 10 acquires plural records used in building a credit-evaluating model for businesses as shown in Table 1.

In step S102, the sign condition acquisition unit 20 acquires the sign conditions as shown in Table 2.

In step S103, the estimation unit 30 executes maximum likelihood estimation. More specifically, the estimation unit 30 calculates an estimate of each parameter that maximizes likelihood function L(θ) in the variable selecting model. The estimate is calculated from plural records acquired in step S101, also under the sign conditions acquired in step S102, i.e., the following condition C₁:

C₁: β₁≥0, β₂≥0, β₃≥0, β₄≥0, β₅≥0, . . .

A maximum likelihood estimator of a parameter vector θ defined in this step

\hat{θ}=(\hat{α}, \hat{β}₁, \hat{β}₂, . . .) (10)

holds

$$\hat{θ} = {arg max}_{θ ∈ {C}_{1}} L ( θ ) = {arg max}_{θ ∈ {C}_{1}} \{ {\prod }_{i = 1}^{N} {{PD}_{i}^{{D}_{i}} ( 1 - {PD}_{i} )}^{1 - {D}_{i}} \}$$

As explained above, L(θ) represents the likelihood function; N is the number of records in Table 1; and Dᵢ is a default flag for the business i.

The maximum likelihood estimator given by equation (10) is estimated as θ that maximizes likelihood function L(θ) under condition C₁.

There are plural algorithms for finding a maximum of likelihood function L(θ) under condition C₁ as above. A coordinate descent method and a steepest descent method, for example, are known. Of these, the coordinate descent method, for example, can target numerous candidate explanatory variables quickly. Any kind of algorithm is available in this embodiment.

Here, it is known that an estimator of this embodiment, calculated from a conditional parameter value, shows the same asymptotic normality or consistency as a normal maximum likelihood estimator. Details thereof can be found in Non-Patent Literature “T. J. Moore, B. M. Sadler, Maximwn-likelihood estimation and scoring under parametric constrains. Army Research Lab, Aldelphi, MD, Tech. Rep. ARL-TR-3805, 2006”.

Table 3 shows estimates of the parameters obtained in this step.

TABLE 3
Estimates of Constant/Coefficient

| Constant/Coefficient | Estimate |
|---|---|
| α | 8.90 |
| β₁ | 0.00 |
| β₂ | 0.00 |
| β₃ | 0.00 |
| β₄ | 6.77 |
| β₅ | −437.16 |
| . . . | . . . |

Coefficients β₁, β₂, and β₃ corresponding to sales, a capital ratio, and years of debt redemption, respectively, are all estimated to be zero. Coefficients β₄ and β₅ corresponding to a current ratio and a ratio of interest burden to sales, respectively, are each estimated as a non-zero coefficient, which satisfies the sign conditions.

In step S104, the selection unit 40 selects desired explanatory variables. More specifically, it determines whether a coefficient value estimated in step S103 is zero or non-zero, and selects candidate explanatory variables corresponding to the non-zero coefficient as desired explanatory variables. In this embodiment, the current ratio and the ratio of interest burden to sales corresponding to non-zero coefficients β₄ and β₅, respectively are selected as desired explanatory variables.

A desired statistical model with the selected variables is:

$$\{ \begin{matrix}\begin{matrix}Z = α + {β}_{4} {x}_{4} + {β}_{5} {x}_{5} + ⋯ \\ = 8.90 + 6.77 {x}_{4} + ( - 437.16 ) {x}_{5} + ⋯\end{matrix} \\ PD = \frac{1}{1 + exp ( Z )} \end{matrix}$$

where x₄ and x₅ indicate desired explanatory variables, corresponding to candidate explanatory variables X₄ and X₅, respectively.

### Advantageous Effects

This embodiment ensures rapid variable selection. As mentioned above, rapid estimation can be effected even on numerous candidate explanatory variables by using the coordinate descent method or other such algorithms. Moreover, the selection of explanatory variables can be done within almost the same time as normal maximum likelihood estimation with no sign condition.

Also, a set of candidate explanatory variables, as can maximize the likelihood under predetermined sign conditions, are selected, thereby eliminating the necessity for any manual post-processing. The sign-restricted variable selection and the unrestricted selection are compared below.

In FIG. 4, the horizontal axis represents coefficient β₄, the vertical axis represents coefficient β₂, and contour lines CL indicate the likelihood. The farther from a region R, the lower the likelihood. In this embodiment, estimation is made under condition C₁. That is, the estimation targets the first quadrant Q₁. This yields point K₁ as an estimate. Estimates satisfying the sign conditions, like a positive estimate for coefficient β₄ and an estimate of zero for coefficient β₂, can be obtained.

In contrast, FIG. 5 shows estimation without condition C₁ or other such conditions. The estimation targets all quadrants from the first quadrant Q₁ to the fourth quadrant Q₄, whereby point K₂, not satisfying the sign conditions, is found as an estimate.

As understood from the above, if no condition is set, the estimation has to target a wider range, and a resultant estimate may not satisfy the sign conditions. In contrast, according to this embodiment, the estimation is done under condition C₁ compliant with the sign conditions. This accordingly limits the target estimation range as well as provides an estimate satisfying the sign conditions. That is, an efficient estimation is possible.

As mentioned above, if the number of explanatory variables increases, it is more difficult to attain a statistical model that can satisfy sign conditions. This means that, if numerous candidate explanatory variables exist, many coefficients assume zero at a point where the likelihood function is maximized under the sign conditions like condition C₁. In other words, setting the sign conditions narrows down the explanatory variables.

Moreover, a desired set of explanatory variables can be selected, which maximizes the likelihood, from among all possible sets of variables satisfying the sign conditions. Thus, it is possible to find a set of explanatory variables that shows a high likelihood compared with a stepwise method or other such conventional methods. That is, a model of higher precision than a conventional one can be provided. In this regard, none of the conventional stepwise method, lasso regression, and elastic net consider any sign condition in the process of variable selection. In general, there is no choice but to find a set of explanatory variables satisfying sign conditions by trial and error.

The stepwise method or brute-force regression requires several maximum likelihood estimations, whereas this embodiment requires only one estimation. Also, the one estimation enables selection of explanatory variables as well as estimation of corresponding coefficients.

The lasso regression or elastic net generally involves additional analysis for determining the aforementioned hyperparameter. Also, the selection of explanatory variables generally depends on the way to determine the hyperparameter. This embodiment does not use a variable like the hyperparameter, and thus, requires no additional analysis. Furthermore, a set of explanatory variables, which maximizes the likelihood function under the sign conditions, can always be selected.

### Second Embodiment

Any constraint can also be set together with the sign conditions. The constraints defines at least one of upper and lower limits for every possible value of each coefficient. Table 4 shows an example of the constraints. The constraints are stored in the auxiliary storage device 56.

TABLE 4
Sign Condition and Constraint

Constraint

| Coefficient | Sign Condition | Upper Limit | Lower Limit |
|---|---|---|---|
| β₁ | 0 or more | | |
| β₂ | 0 or more | | 10.00 |
| β₃ | 0 or less | −1.00 | |
| β₄ | 0 or more | | |
| β₅ | 0 or less | | −250.00 |
| . . . | . . . | . . . | . . . |

In Table 4, empty fields of “upper limit” imply that no upper limit is set for a coefficient concerned. The same applies to the lower limit. For example, the lower limit is set to 10.00 for coefficient β₂, while no upper limit is set therefor. As for coefficient β₁, no constraint is set.

A constraint for a certain coefficient needs to match a sign condition thereof. If the sign condition is “0 or more”, the upper and lower limits should be positive. If the sign condition is “0 or less”, the upper and lower limits should be negative,

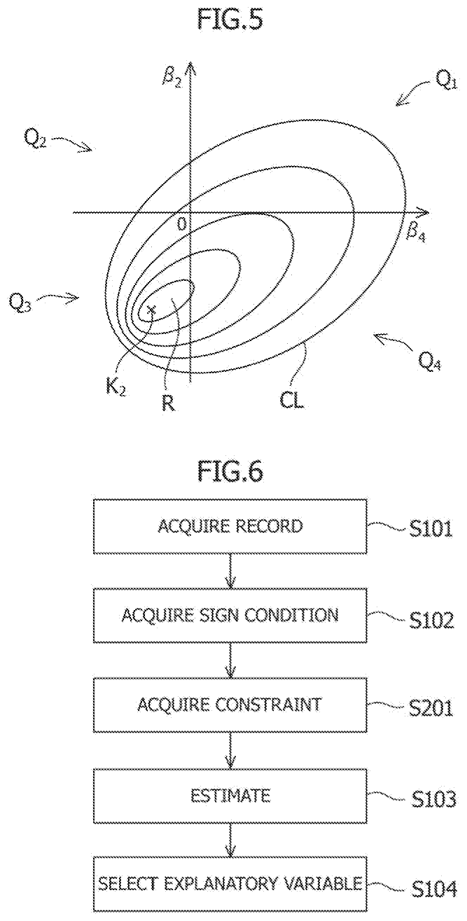

In this embodiment, the variable selecting apparatus 1 further includes a. constraint acquisition unit (not shown). FIG. 6 shows a processing flow of the variable selecting apparatus 1. The difference from FIG. 3 is that step S201 is added between steps S102 and S103. In step S201, the constraint acquisition unit acquires constraints. Then, the estimation is made in step S103 under the sign conditions and the constraints, i.e., under condition C₂:

C₂: β₁≥0, β₂≥10.0, β₃≤−1.0, β₄≥0, −250.0≤β₅, . . .

Then, a maximum likelihood estimator of a parameter vector θ given by the estimation holds:

$$\hat{θ} = {arg max}_{θ ∈ {C}_{2}} \{ {\prod }_{i = 1}^{N} {{PD}_{i}^{{D}_{i}} ( 1 - {PD}_{i} )}^{1 - {D}_{i}} \}$$

Table 5 shows estimates of the parameters obtained in this step.

TABLE 5
Estimates of Constant/Coefficient

| Constant/Coefficient | Estimate |
|---|---|
| α | 5.66 |
| β₁ | 0.00 |
| β₂ | 10.00 |
| β₃ | −1.32 |
| β₄ | 2.77 |
| β₅ | −250.00 |
| . . . | . . . |

In this embodiment, coefficients β₂ and β₃, which are estimated to be zero in the first embodiment, are estimated to be non-zero.

The estimator of the coefficient given the upper or lower limit does not always match the upper or lower limit. As with coefficient β₃ in Table 5, a value greater than the upper or lower limit in absolute value, may be selected.

An absolute value of an estimator corresponding to the ratio of interest burden to sales (coefficient β₅) is decreased because of its lower limit. That is, the statistical model reduces an influence of the ratio of interest burden to sales. As with the current ratio (coefficient β₅) in Table 5, the estimator of a candidate explanatory variable with no constraint also differs from that in the first embodiment due to the influence of the change in coefficients of other candidate explanatory variables.

In subsequent step S104, the selection unit 40 selects explanatory variables. More specifically, it selects as desired explanatory variables a capital ratio, years of debt redemption, a current ratio, and a ratio of interest burden to sales corresponding to non-zero coefficient β₂-β₅, respectively.

This embodiment ensures that specific candidate explanatory variables, such as the capital ratio or the years of debt redemption, can be necessarily selected as desired explanatory variables by setting constraints. That is, it is possible to respond to a demand to “select some specific candidate explanatory variables as desired explanatory variables”. Furthermore, setting constraints prevent some specific explanatory variables from having too great influences on variable selection. Note that a constraint can be set for at least one of coefficients having sign conditions.

### Third Embodiment

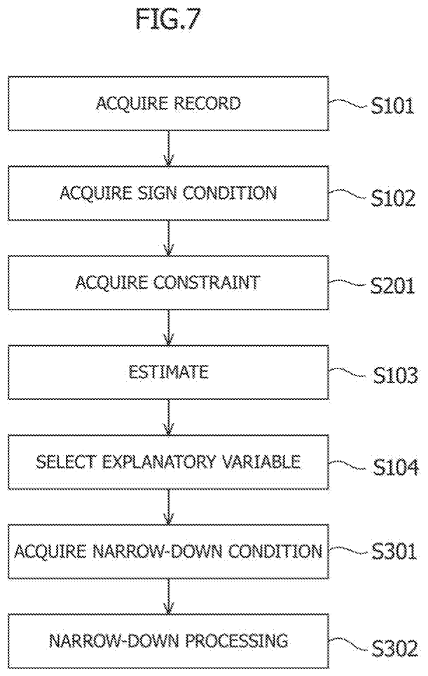

In this embodiment, the variable selecting apparatus 1 further includes a narrow-down condition acquisition unit and a narrow-down processing unit (both not shown). As shown in FIG. 7, if multiple explanatory variables are selected in step S104, steps S301 and S302 may follow this step.

In step S301, the narrow-down condition acquisition unit acquires narrow-down conditions. The narrow-down conditions are to narrow down the multiple explanatory variables selected in step S104, The narrow-down conditions are stored in the auxiliary storage device 56. Examples of the narrow-down conditions are:

“excluding explanatory variables of which the p-value or t-value is below a certain level”; and

“deleting variables by backward elimination starting with a set of desired explanatory variables selected in step S104 (initial values)”.

In step S302, the narrow-down processing unit executes narrow-down processing under the narrow-down conditions so as to reduce the number of explanatory variables.

According to this embodiment, setting the narrow-down conditions makes it possible to delete explanatory variables that are not statistically significant, and to build a model using fewer explanatory variables without lowering the model precision, i.e., with almost the same precision. Here, even if deleting explanatory variables that are not statistically significant, influence on coefficients corresponding to the other explanatory variables is very small. Hence, there is almost no risk that the sign conditions cannot be met due to the narrow-down processing.

Note that steps S301 and S302 may follow step S103 of FIG. 6.

### Fourth Embodiment

An embodiment of the ordered logit model in which a response variable is expressed by an ordinal scale consisting of three or more values, is described below. The processing flow is similar to that of FIG. 3, except for the following.

Table 6 shows an example of model building data used for building an ordered logit model to estimate business ratings. The data is acquired in step S101.

TABLE 6
Model Building Data

| | | | | Financial Indicator (Candidate Explanatory Variable) | | | | | |
|---|---|---|---|---|---|---|---|---|---|
| | | | | | | | | Burden | |
| | | | | | | Years of | | Ratio of | |
| Business Attributes | | | | Logarithm | Capital | Debt | Current | Interest | |
| Business | Business | Business | | of Sales | Ratio | Redemption | Ratio | to Sales | |
| ID | Name | Type | Rating | (k = 1) | (k = 2) | (k = 3) | (k = 4) | (k = 5) | . . . |
| 1 | Business A | Construction | 2 | 9.016 | 46.82% | 6.43 | 129.95% | 1.29% | . . . |
| 2 | Business B | Manufacturer | 2 | 8.669 | 38.71% | 4.73 | 148.03% | 2.88% | . . . |
| 3 | Business C | Retailer | 4 | 9.474 | 19.86% | 16.82 | 101.74% | 4.51% | . . . |
| 4 | Business D | Supplier | 1 | 10.318 | 64.93% | 2.11 | 211.30% | 0.47% | . . . |
| . | . | . | . | . | . | . | . | . | . . . |
| . | . | . | . | . | . | . | . | . | |
| . | . | . | . | . | . | . | . | . | |

The “rating” indicates the level of business's debt payment ability in numbers or letters. In this embodiment, the credit ranks higher in right to left order of 1>2>3>4> . . . >Nr where Nr represents the number of ratings. The ratings may be given letter grades like “AAA, AA+, AA, . . . ” or “grade A, grade B, grade C, . . . ”. Either indicates credit ranks, which can be rewritten in numbers as in this embodiment.

The model for estimating a business's rating like the ordered logit model is called a “rating estimation model”. The rating estimation model is also a type of credit-evaluating model.

The rating estimation model, constructed using the ordered logit model, supposes that an estimate of a probability that the business i is given a rating s holds:

$${p}_{i , s} ≡ Pr \{ {r}_{i} = s \} = \frac{1}{1 + exp ( {Z}_{i , s} )} - \frac{1}{1 + exp ( {Z}_{i , s - 1} )} , \\ {Z}_{i , s} = \{ \begin{matrix}∞ & ( s = 0 ) \\ {α}_{s} + {β}_{1} {X}_{i , 1} + {β}_{2} {X}_{i , 2} + ⋯ & ( 1 \leq s \leq {N}_{r} - 1 ) \\ - ∞ & ( s = {N}_{r} )\end{matrix}$$

where

p_{i,s}: a probability that the business i is given a rating s

rᵢ: a variable indicating a rating of the business i

X_{i,k}: an occurrence of a k-th possible explanatory variable for the business i

Z_{i,s}: a linear predictor for the rating s of the business i

αₛ: a constant term for Z.

βₖ: a coefficient corresponding to a possible explanatory variable (common to every s).

Likelihood function L(θ) of the rating estimation model is:

$$L ( θ ) = {\prod }_{i = 1}^{N} {\prod }_{s = 1}^{{N}_{r}} {p}_{i , s}^{{δ}_{i , s}} \qquad ( 11 )$$

where

δ_{1,x}: a variable that is 1 for the rating s of the business i, or otherwise 0.

Regarding the rating estimation model, when executing estimation in step S103 under the sign conditions acquired in step S102 of FIG. 3, an estimate in the variable selecting model is calculated from:

$$\hat{θ} = {arg max}_{θ ∈ {C}_{1}} \{ L ( θ ) \}$$

where condition C₁ is the same as in the first embodiment, and L(θ) indicates the aforementioned likelihood function.

Table 7 shows examples of the parameters obtained in step S103.

TABLE 7
Estimates of Constant/Coefficient

| Constant/Coefficient | Estimate |
|---|---|
| α₁ | 7.56 |
| α₂ | 6.32 |
| . . . | . . . |
| α_{Nr} | 1.49 |
| β₁ | 0.00 |
| β₂ | 18.92 |
| β₃ | −1.88 |
| β₄ | 0.00 |
| β₅ | −78.12 |
| . . . | . . . |

Considering the results in Table 7, the capital ratio, the years of debt redemption, and the ratio of interest burden to sales, . . . are selected as explanatory variables in step S104.

As mentioned above, the variable selecting apparatus 1 can be configured to select desired explanatory variables from plural candidate explanatory variables in the statistical model that expresses, by a predetermined function, a relationship between plural linear predictors (Z_{i,s}) and an expectation value of a response variable or the probability of the response variable being certain values, by using the variable selecting model that defines the respective linear predictors by the sum of the constant and the linear combination of the candidate explanatory variables and their corresponding coefficients.

### Fifth Embodiment

When a response variable is expressed by an ordinal scale consisting of three or more values, the following sequential logit model can be used for modeling as well. In the sequential logit model, plural binominal logit models for estimating the probability of being the rating s or less are used to estimate a probability for every rating. A processing flow is similar to FIG. 3.

$${q}_{i , s} ≡ Pr \{ {r}_{i} = s \vert {r}_{i} \geq s \} = \frac{1}{1 + exp ( {Z}_{i , s} )} , \\ {Z}_{i , s} = \{ \begin{matrix}{α}_{s} + {β}_{1 , s} {X}_{i , 1} + {β}_{2 , s} {X}_{i , 2} + ⋯ & ( 1 \leq s \leq {N}_{r} - 1 ) \\ - ∞ & ( s = {N}_{r} )\end{matrix} \\ {p}_{i , s} ≡ Pr \{ {r}_{i} = s \} = \{ \begin{matrix}{q}_{i , s} & ( s = 1 ) \\ {\prod }_{r = 1}^{s - 1} ( 1 - {q}_{i , r} ) {q}_{i , s} & ( 1 < s < {N}_{r} ) \\ {\prod }_{r = 1}^{{N}_{r} - 1} ( 1 - {q}_{i , r} ) & ( s = {N}_{r} )\end{matrix}$$

where

X_{i,k}: an occurrence of a k-th possible explanatory variable for the business i

Z_{i,s}: a linear predictor for the rating s of the business i

αₛ: a constant term for Z_{i,s}

β_{k,s}:a coefficient corresponding to an explanatory variable k for (that varies depending on s).

A likelihood function for the sequential logit model is exactly the same as the likelihood function (equation (11)) of the ordered logit model only except p_{i,s}.

When executing estimation with the sequential logit model in step S103 only under the sign conditions acquired in step S102, an estimate of the parameter in the variable selecting model is derived from:

$$\hat{θ} = {arg max}_{θ ∈ {C}_{3}} \{ L ( θ ) \}$$

where condition C₃ is:

C₃: ∀_{S}, β_{1,s}≥0, β_{2,s}≥0, β_{3,s}≤0, β_{4,s}≥0, β_{5,s}≤0, . . .

Table 8 shows examples of the parameters obtained in this embodiment.

TABLE 8
Estimates of Constant/Coefficient

Estimate

| Indicator Name | S = 1 | S = 2 | S = 3 | . . . |
|---|---|---|---|---|
| αₛ | 9.61 | 6.68 | 5.32 | . . . |
| β_{1, s} | 0.78 | 0.00 | 0.53 | . . . |
| β_{2, s} | 11.56 | 10.29 | 0.00 | . . . |
| β_{3, s} | −3.51 | 0.00 | −6.41 | . . . |
| β_{4, s} | 0.00 | 5.32 | 0.00 | . . . |
| β_{5, s} | −63.21 | 0.00 | −437.16 | . . . |
| . . . | . . . | . . . | . . . | . . . |

The coefficient and the constant are estimated for each value of Z_{i,s} (each rating), and explanatory variables selected in step S104 also varies depending on Z_{i,s}.

As mentioned above, the variable selecting apparatus 1 can be configured to select desired explanatory variables from plural candidate explanatory variables in the statistical model that expresses, by a predetermined function, a relationship between plural linear predictors (Z_{i,s}) and an expectation value of a response variable or the probability of the response variable being certain values, by using the variable selecting model that defines at least one of the plural linear predictors (e.g., Z_{i,2}) by the sum of the constant and the linear combination of the plural candidate explanatory variables and their corresponding coefficients.

### Sixth Embodiment

The foregoing sign conditions and constraints both define a set of every possible coefficient value. Accordingly, both of them are collectively referred to as constraints below.

In this embodiment, conceivable examples of the constraints that define the set of every possible coefficient value for each coefficient are given below.
First constraint: finite or semi-infinite interval including zero as an endpoint
Second constraint: union of a finite or semi-infinite interval including zero as an endpoint, and an interval not including zero
Third constraint: set including zero as an isolated point and also including an element other than zero
Fourth constraint: set of all possible values

Note that the isolated point of a set refers to an element that has a neighborhood which does not include any elements of the set other than the isolated point itself.

Next, specific examples of the constraint are given below. In these examples, β is a coefficient corresponding to a certain candidate explanatory variable, and τ, τ₁, and τ₂ are positive values satisfying the condition of τ₁≤τ₂.

| | | |
|---|---|---|
| Example 1 | [0, ∞) | (⇔ β ≥ 0) |
| Example 2 | [0, τ] | (⇔ 0 ≤ β ≤ τ) |
| Example 3 | (−∞, 0] ∪ [τ, ∞) | (⇔ β ≤ 0 or τ ≤ β) |
| Example 4 | {0} ∪ [τ, ∞) | (⇔ β = 0 or τ ≤ β) |
| Example 5 | (−∞, − τ₁] ∪ | (⇔ β ≤ − τ₁ or |
| | {0} ∪ [τ₂, ∞) | β = 0 or τ₂ ≤ β) |

Example 1 is an example of the above first constraint. A set of possible values for the coefficient β is a semi-infinite interval including zero at the left endpoint. According to this constraint, only when an estimate of the coefficient β is a positive value, a candidate explanatory variable corresponding to the coefficient is selected as an explanatory variable.

Example 2 is also an example of the above first constraint. A set of possible values for the coefficient β is a finite interval including zero at the left endpoint. According to this constraint, only when an estimate of the coefficient β is a positive value, a candidate explanatory variable corresponding to the coefficient is selected as an explanatory variable, and the maximum value of the coefficient β is τ when selected as an explanatory variable. By setting such an upper limit, it is possible to avoid such a situation that the explanatory variable corresponding to the coefficient β has a substantial influence on a statistic model.

Example 3 is an example of the above second constraint. A set of possible values for the coefficient β is the union of a semi-infinite interval including zero at the right endpoint and a semi-infinite interval including τ at the left endpoint (i.e., interval not including zero). According to this constraint, only when an estimate of the coefficient β is a negative value or a positive value which is equal to or greater than τ, a candidate explanatory variable corresponding to the coefficient is selected as an explanatory variable.

Example 4 is an example of the above third constraint. A set of possible values for the coefficient β includes zero as an isolated point and also includes an element other than zero (element in a semi-infinite interval including τ at the left endpoint). According to this constraint, only when an estimate of the coefficient β is a positive value and is equal to or greater than τ, a candidate explanatory variable corresponding to the coefficient is selected as an explanatory variable. Unlike Example 1 in which the sign of a possible value for a coefficient is designated, there is no possibility that an estimate of the coefficient β is a positive value less than τ, whereby candidate explanatory variables of less significance are not selected as explanatory variables.

Example 5 is also an example of the above third constraint. A set of possible values for the coefficient β includes zero as an isolated point and also includes an element other than zero (element in a semi-infinite interval including −τ₁ at the right endpoint and element in a semi-infinite interval including τ₂ at the left endpoint). According to this constraint, when a candidate explanatory variable corresponding to the coefficient is selected as an explanatory variable, the absolute value of the estimate of the coefficient β is τ₁ or more.

Here, as discussed above, in the statistic model, “expectation value of weight=α+β₁×height+β₂×waist size”, the coefficients β₁ and β₂ are expected to have the positive sign. As such, the expected sign is referred to as “natural sign”. However, the natural sign is not necessarily able to be set for every candidate explanatory variable. For example, regarding another candidate explanatory variable, or a heart rate, it is difficult to assume the natural sign for a coefficient corresponding to this candidate explanatory variable. Thus, the constraint of Example 5 above is effective to a coefficient of which the natural sign cannot be easily assumed.

τ, τ₁, and τ₂ can be determined by any method. These may be determined empirically, or logically so that the coefficient has at least a certain level of significance. Note that Examples 1 to 5 merely exemplify the aforementioned first to third constraints.

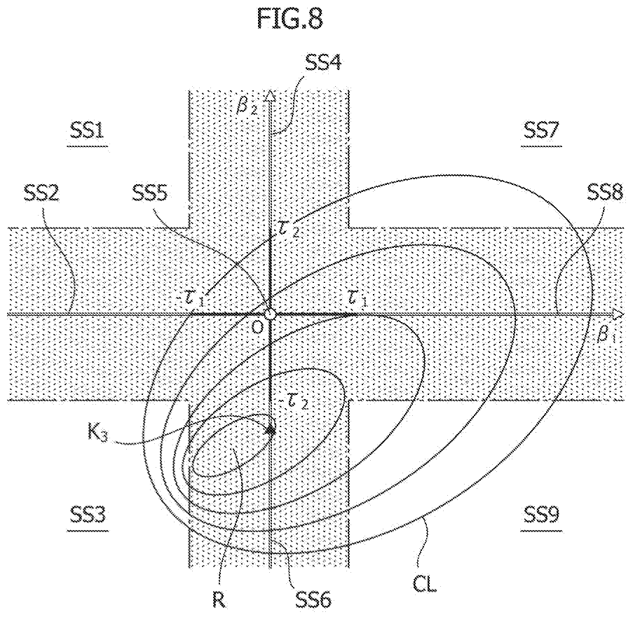

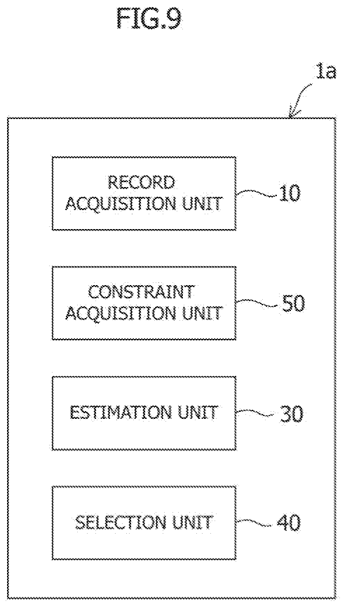

FIG. 8 is another example of a conceptual diagram of how to estimate a coefficient according to this embodiment. In this example, a coefficient value which will maximize a likelihood function under a preset constraint, is estimated. In FIG. 8, the horizontal axis represents coefficient β₁ corresponding to a certain candidate explanatory variable, the vertical axis represents coefficient β₂ corresponding to another candidate explanatory variable, and contour lines CL indicate the likelihood. The farther from the region R, the lower the likelihood.

The constraints for the coefficients β₁ and β₂ are as follows. Here, τ₁ and τ₂ are both positive values.
Constraint for coefficient β₁: β₁≤−τ₁ or β₁=0 or τ₁≤β₁
Constraint for coefficient β₂: β₂≤−τ₂ or β₂=0 or τ₂≤β₂

FIG. 8 also shows subsets SS1 to SS9 included in the set of possible values for the coefficients β₁ and β₂. The respective subsets are defined below
SS1: β₁≤−τ₁ and τ₂≤β₂
SS2: β₁≤−τ₁ and β₂=0
SS3: β₁≤−τ₁ and τ₂≤τ₂
SS4: β₁=0 and τ₂≤β₂
SS5: β₁=0 and β₂=0
SS6: β₁=0 and β₂≤−τ₂
SS7: τ₁≤β₁ and τ₂≤β₂
SS8: τ₁≤β₁ and β₂=0
SS9: τ₁≤β₁ and β₂≤−τ₂

Under such constraints, the coefficients β₁ and β₂ are estimated. As a result, a point K₃ on the vertical axis is estimated. Specifically, an estimate of the coefficient β₁ is zero, and an estimate of the coefficient β₂ is a negative value, which is equal to or less than −τ₂. That is, a candidate explanatory variable corresponding to the coefficient β₁ is not selected as an explanatory variable, and a candidate explanatory variable corresponding to the coefficient β₂ is selected as an explanatory variable.

### EXAMPLE 1

### Variable Selection in Linear Multiple Regression Model

Next, described is Example of variable selection in a linear multiple regression model. In the linear multiple regression model, it is assumed that an expectation value of a response variable is given as a linear combination of plural explanatory variables. A model equation is as follows:

E[Y]=α+β₁_{^{x}}₁+β₂_{^{x}}₂+. . .

In this equation, Y is a response variable, xₖ (k=1, 2, . . . ) is a candidate explanatory variable, α is a constant, and βₖ is a coefficient corresponding to the candidate explanatory variable xₖ. In this linear multiple regression model, function F (called “link function”) representing a relationship between an expectation value of the response variable Y and a linear predicator is an identity function. Upon building the linear multiple regression model, a highly descriptive combination of explanatory variables is selected from a number of candidate explanatory variables in many cases.

Table 9 shows plural records used upon building a linear multiple regression model.

TABLE 9
Data for Building Linear Multiple Regression Model

| Sample | | | | | | | | | | | |
|---|---|---|---|---|---|---|---|---|---|---|---|
| ID | Y | x₁ | x₂ | x₃ | x₄ | x₅ | x₆ | x₇ | x₈ | x₉ | x₁₀ |
| 1 | 1.59 | 0.18 | 1.74 | 0.98 | −2.33 | 0.23 | 0.93 | 0.35 | −0.98 | 0.27 | −0.18 |
| 2 | 2.18 | 1.52 | 1.83 | −1.77 | −0.32 | −0.85 | 0.02 | −0.40 | −0.20 | −0.20 | −0.63 |
| 3 | 4.11 | −0.28 | −0.72 | −0.65 | 0.06 | 1.91 | 0.42 | −1.41 | −2.34 | 1.14 | −0.36 |
| 4 | 5.63 | 0.15 | −0.97 | 0.10 | −0.79 | −0.52 | −0.23 | 0.46 | −0.20 | −0.26 | −1.56 |
| 5 | −1.35 | −0.85 | 0.02 | −1.02 | −0.31 | −1.04 | −0.64 | −1.22 | −0.57 | 1.24 | −0.71 |
| 6 | 1.02 | 1.22 | 0.83 | 0.76 | 0.33 | −1.67 | −0.63 | −0.37 | 1.46 | −2.03 | −2.04 |
| . | . | . | . | . | . | . | . | . | . | . | . |
| . | . | . | . | . | . | . | . | . | . | . | . |
| . | . | . | . | . | . | . | . | . | . | . | . |

Each record includes a realization of a response variable and realizations of plural candidate explanatory variables. In this example, ten candidate explanatory variables are given by way of example, but the number of candidate explanatory variables varies from problem to problem and may be about tens to hundreds.

In this Example, it is assumed that all candidate explanatory variables are standardized so that they are standard normally distributed, in order to easily understand the significance of each coefficient. Note that, in general, candidate explanatory variables are not standardized and have different levels, whereby the significance of each candidate explanatory variable cannot be determined based on an absolute value of the corresponding coefficient. This Example can be applied even if candidate explanatory variables are not standardized.

Table 10 shows examples of constraints for the respective coefficients. For a coefficient with only one of Condition 1 to 3, a set of possible values for the coefficient is a set defined by the one condition. For a coefficient with two or more of Condition 1 to 3, a set of possible values for the coefficient is the union of two or more sets respectively defined by the two or more conditions. For a coefficient without any Condition 1 to 3, a set of possible values for the coefficient is a set of all possible values.

TABLE 10
Example of Constraint

| | Candidate | | | |
|---|---|---|---|---|
| | explanatory | Constraint | | |
| Coefficient | variable | Condition 1 | Condition 2 | Condition 3 |
| β₁ | x₁ | 0 or more | | |
| β₂ | x₂ | 0 or less | | |
| β₃ | x₃ | 0 or more | | |
| β₄ | x₄ | 0 or less | | |
| β₅ | x₅ | −0.5 or less | Equal to zero | 0.5 or more |
| β₆ | x₆ | −2.0 or less | Equal to zero | 1.0 or more |
| β₇ | x₇ | −1.0 or less | Equal to zero | 1.0 or more |
| β₈ | x₈ | −1.5 or less | | |
| β₉ | x₉ | 1.0 or more | | |
| β₁₀ | x₁₀ | | | |

The constraints for the coefficients to β₁ to β₄ are simple constraints that define the sign of each coefficient.

According to the constraint for the coefficient β₅, a set of possible values for the coefficient β₅ includes zero as an isolated point and also includes an element other than zero. The same applies to the coefficients β₆ and β₇.

According to the constraint for the coefficient β₈, set of possible values for the coefficient β₈ does not include zero. The same applies to the coefficient β₉. That is, the candidate explanatory variable x₈ corresponding to the coefficient β₈ and the candidate explanatory variable x₉ corresponding to the coefficient β₉ are assuredly selected as explanatory variables.

Note that none of Conditions 1 to 3 are set for the coefficient β₁₀, and all possible values can be selected. Such a condition can be said to be a kind of constraints that specify a set of “all values” as a possible value for the coefficient β₁₀.

Table 11 shows estimates of parameters (constant α and coefficient βₖ) obtained under the constraints in Table 10.

TABLE 11
Estimate of Parameter

| Parameter | α | β₁ | β₂ | β₃ | β₄ | β₅ | β₆ | β₇ | β₈ | β₉ | β₁₀ |
|---|---|---|---|---|---|---|---|---|---|---|---|
| Estimate | 2.05 | 2.42 | −1.85 | 0.12 | 0.00 | 0.00 | 1.00 | 1.33 | −1.50 | 1.00 | −0.01 |

As shown in Table 11, an estimate of the respective coefficients β₁ to β₃ is non-zero.

An estimate of the coefficient β₄ is zero. Specifically, the candidate explanatory variable x₄ is not selected as an explanatory variable.

Regarding the coefficient β₅, there exists no estimate of which an absolute value is 0.5 or more, and an estimate thereof is zero. Specifically, the candidate explanatory variable x₅ is not selected as an explanatory variable.

The coefficient β₆ is estimated to be 1.0 as the lower limit specified by the constraint, Condition 3.

The coefficient β₈ is estimated to be −1.5 as the upper limit specified by the constraint. Condition 1,

The coefficient β₉ is estimated to be 1.0 as the lower limit specified by the constraint, Condition 1.

As described above, estimates of all coefficients satisfy a corresponding constraint.

As shown in Table 11, estimates of the coefficients β₃ and β₁₀ are not zero but their absolute values are relatively small and thus, the significance of the candidate explanatory variables x₃ and x₁₀ is considered to be low It can be said that “a smaller absolute value means a low significance” because explanatory variables are standardized as described above.

Table 12 shows modifications of the constraints for coefficients β₃ and β₁₀ among the constraints shown in Table 10.

TABLE 12
Example of Constraint

| | Candidate | | | |
|---|---|---|---|---|
| | explanatory | Constraint | | |
| Coefficient | variable | Condition 1 | Condition 2 | Condition 3 |
| β₁ | x₁ | 0 or more | | |
| β₂ | x₂ | 0 or less | | |
| β₃ | x₃ | 1.0 or more | Equal to zero | |
| β₄ | x₄ | 0 or less | | |
| β₅ | x₅ | −0.5 or less | Equal to zero | 0.5 or more |
| β₆ | x₆ | −2.0 or less | Equal to zero | 1.0 or more |
| β₇ | x₇ | −1.0 or less | Equal to zero | 1.0 or more |
| β₈ | x₈ | −1.5 or less | | |
| β₉ | x₉ | 1.0 or more | | |
| β₁₀ | x₁₀ | −1.0 or less | Equal to zero | 1.0 or more |

Table 13 shows estimates of parameters (constant α and coefficient βₖ) obtained under the constraints in Table 12.

TABLE 13
Estimate of Parameter

| Parameter | α | β₁ | β₂ | β₃ | β₄ | β₅ | β₆ | β₇ | β₈ | β₉ | β₁₀ |
|---|---|---|---|---|---|---|---|---|---|---|---|
| Estimate | 2.04 | 2.43 | −1.88 | 0.00 | 0.00 | 0.00 | 1.00 | 1.34 | −1.50 | 1.00 | 0.00 |

By changing the constraints for the coefficients β₃ and β₁₀, corresponding candidate explanatory variables x₃ and x₁₀ are not selected anymore as explanatory variables. Specifically, the candidate explanatory variables x₃ and x₁₀ of less significance can be subtracted from a model along with the estimation of parameters. This is realized by changing the constraints for the coefficient β₃ and β₁₀ so that sets of possible values for these two coefficients include zero as an isolated point.

### EXAMPLE 2

### Variable Selection in Logistic Regression Model

Next, described is Example of variable selection in a logistic regression model. The logistic regression model is to estimate the probability of occurrence of a certain event and is expressed by a model equation below:

$${Z}_{i} = α + {β}_{1} {X}_{i , 1} + {β}_{2} {X}_{i , 2} + ⋯ , {P}_{i} = \frac{1}{1 + exp ( - {Z}_{i} )}$$

In this equation, i is a sample ID, X_{i, k} is a k-th candidate explanatory variable Xₖ of the sample i, a linear predictor Zᵢ is a score of the sample i, and Pᵢ is an estimate of the probability that the event will occur in the sample i. In addition, α is a constant, and βₖ is a coefficient corresponding to the k-th candidate explanatory variable Xₖ.

The above event and candidate explanatory variables vary depending on object to be modeled, but this Example is applicable regardless of events and candidate explanatory variables, For example, for a default event of an obligor, various financial indicators of the obligor can be set as a candidate explanatory variable.

Provided that θ is a parameter vector, i.e., θ=(α, β₁, β₂, . . . ) and no constraint is set for each coefficient, the maximum likelihood estimator is given by:

$$\hat{θ} = {arg max}_{θ} \{ {\prod }_{i = 1}^{N} {{P}_{r} ( θ )}^{{D}_{i}} {( 1 - {P}_{i} ( θ ) )}^{1 - {D}_{i}} \}$$

In this equation, Dᵢ is an occurrence flag for the event in the sample i. Dᵢ is a response variable in this model. If the event occurs in the sample i, Dᵢ=1 or otherwise, Dᵢ=0. N is the number of samples.

Table 14 shows an example of data used for building a logistic regression model. Each record includes a realization of the occurrence flag Dᵢ as the response variable and realizations of plural candidate explanatory variables.

TABLE 14
Data for Building Logistic Regression Model

| Sample | | | | | | | | |
|---|---|---|---|---|---|---|---|---|
| ID | Dᵢ | x₁ | x₂ | x₃ | x₄ | x₅ | . . . | x₁₀₀ |
| 1 | 0 | 0.13 | 2.08 | 0.57 | −0.02 | 0.35 | . . . | −0.79 |
| 2 | 0 | −3.45 | 0.62 | −0.78 | 0.81 | 1.24 | . . . | −2.59 |
| 3 | 1 | −2.09 | 0.22 | 0.54 | −0.78 | −0.57 | . . . | 0.41 |
| 4 | 0 | 0.20 | −0.86 | −0.34 | −0.36 | 0.82 | . . . | 0.56 |
| 5 | 1 | 1.39 | 0.00 | 0.35 | −0.24 | 1.01 | . . . | −0.19 |
| 6 | 0 | −1.18 | −0.18 | 1.58 | 0.27 | −0.22 | . . . | −0.25 |
| . | . | . | . | . | . | . | . . . | . |
| . | . | . | . | . | . | . | | . |
| . | . | . | . | . | . | . | | . |

Table 15 shows an example of constraints for the respective coefficients. A set of constraints for the respective coefficients is the union of sets defined by Conditions 1 and 2.

TABLE 15
Constraint

| Candidate | |
|---|---|
| explanatory | Constraint |

| Coefficient | variable | Condition 1 | Condition 2 |
|---|---|---|---|
| β₁ | x₁ | 1.0 or more | Equal to zero |
| β₂ | x₂ | 1.0 or more | Equal to zero |
| β₃ | x₃ | 1.0 or more | Equal to zero |
| . | . | . | . |
| . | . | . | . |
| . | . | . | . |
| β₁₀₀ | x₁₀₀ | 1.0 or more | Equal to zero |

In this example, it is assumed that a positive sign is set as a natural sign for all coefficients. In addition, when a candidate explanatory variable corresponding to each coefficient is selected as an explanatory variable, a constraint is set to “1.0 or more or 0”, so that the explanatory variable has a certain level of significance. A set defined by this constraint includes zero as an isolated point. A constraint (C₁₅) in Table 15 is expressed as follows:

C₁₅: ∀k, β₁≥1.0 or β₂=0.0

Note that in this example, the same constraint is set for all coefficients, but different conditions may be set for the respective coefficients.

In this Example, estimates of the parameters (constant α and coefficient βₖ) are given by:

$$\hat{θ} = {arg max}_{θ ∈ {C}_{2}} \{ {\prod }_{i = 1}^{N} {{P}_{i} ( θ )}^{{D}_{i}} {( 1 - {P}_{i} ( θ ) )}^{1 - {D}_{i}} \}$$

Various algorithms are conceivable for finding the maximum likelihood under such constraints, but any algorithm is applicable in this Example.

Table 16 summarizes estimates of parameters obtained wider the constraint C₁₅. Candidate explanatory variables corresponding to coefficients of which estimates are non-zero values out of the coefficients to β₁ to β₁₀₀ are selected as explanatory variables. In this example, the coefficients β₃ and β₅ are estimated to be zero, and as understood from this, the candidate explanatory variables x₃ and x₅ are not selected as explanatory variables. Also, the coefficient mo is estimated to be 1.0 as the lower limit defined by Condition 1 under the corresponding constraint.

TABLE 16
Estimate of Parameter

| Parameter | α | β₁ | β₂ | β₃ | β₄ | β₅ | . . . | β₁₀₀ |
|---|---|---|---|---|---|---|---|---|
| Estimate | −3.66 | 3.78 | 2.11 | 0.00 | 1.32 | 0.00 | . . . | 1.00 |

Table 17 shows modifications of the constraints in Table 15. Specifically, the lower limit of each coefficient defined by Condition 1 is changed from 1.0 to 2.0. Table 18 shows estimates of parameters (constant α and coefficient βₖ) obtained under the constraints in Table 17.

TABLE 17
Constraint

| | |
|---|---|
| Candidate | |
| explanatory | Constraint |

| Coefficient | variable | Condition 1 | Condition 2 |
|---|---|---|---|
| β₁ | x₁ | 2.0 or more | Equal to zero |
| β₂ | x₂ | 2.0 or more | Equal to zero |
| β₃ | x₃ | 2.0 or more | Equal to zero |
| . | . | . | . |
| . | . | . | . |
| . | . | . | . |
| β₁₀₀ | x₁₀₀ | 2.0 or more | Equal to zero |

TABLE 18
Estimate of Parameter

| Parameter | α | β₁ | β₂ | β₃ | β₄ | β₅ | . . . | β₁₀₀ |
|---|---|---|---|---|---|---|---|---|
| Estimate | −2.51 | 3.81 | 0.00 | 2.00 | 2.85 | 0.00 | . . . | 0.00 |

From the fact that estimates of the coefficients β₂, β₅, and β₁₀₀ are zero, the candidate explanatory variables x₂, x₅, and x₁₀₀ are not selected as explanatory variables.

An estimate of the coefficient β₂ is non-zero in Table 16 but is zero in Table 18. In contrast, an estimate of the coefficient β₃ zero in Table 16 but is non-zero in Table 18. As such, selecting candidate explanatory variables corresponding to the coefficients β₂ and β₃ produces opposite results according to the constraint. This is because an estimate of a coefficient varies depending on a combination of explanatory variables selected.

By setting a stricter constraint, the number of explanatory variables selected can be reduced. For example, under the constraints in Table 15, forty explanatory variables are selected, whereas under the constraints in Table 17, which are stricter than those in Table 15, twenty-three explanatory variables are selected. Alternatively, a desired number of explanatory variables are intended to be selected in advance and then, constraints may be determined so as to select the desired number of explanatory variables.

The selection of explanatory variables according to this embodiment is executed by a variable selecting apparatus la shown in FIG. 9. The same components as in FIG. 1 are denoted by the same reference numerals. The variable selecting apparatus 1a includes the record acquisition unit 10, a constraint acquisition unit 50, the estimation unit 30, and the selection unit 40. The constraint acquisition unit 50 carries out processing for acquiring constraints. The record acquisition unit 10, the estimation unit 30, and the selection unit 40 carry out the aforementioned processing.

This embodiment is not limited by Examples 1 and 2. According to this embodiment, even when a variable selecting model includes a candidate explanatory variable corresponding to a coefficient for which a natural sign is hardly set in advance, an explanatory variable can be efficiently selected. This is because the constraint is set so that a set of possible values for a target coefficient includes zero as an isolated point. When it is difficult to previously set a natural sign for all coefficients respectively corresponding to all candidate explanatory variables in the variable selecting model, this embodiment is particularly effective.

Also, according to this embodiment, an explanatory variable of high significance can be preferentially selected. Upon estimating a parameter, an estimate of a coefficient corresponding to a candidate explanatory variable of relatively low significance becomes zero without performing the above narrow-down processing, and an explanatory variable can be efficiently selected. This is because when the constraint is set so that a set of possible values for a target coefficient includes zero as an isolated point, the possibility that an estimate of a coefficient corresponding to a candidate explanatory variable of low significance becomes zero, is increased. Note that the narrow-down processing may be performed after the estimation.

In addition, the number of explanatory variables to be selected can be changed by changing the constraint. By setting a stricter constraint, the number of explanatory variables to be selected (i.e., candidate explanatory variables corresponding to a coefficient of which an estimate is non-zero) can be reduced.

This embodiment is applicable not only to a linear regression model and a logistic regression model but also to a generalized linear model including a binomial logit model and an ordered logit model.

### Other Embodiments

When the variable selection has been made, the original indicator itself can be used as a candidate explanatory variable but as needed, the power of the original indicator can be used instead. Alternatively, the original indicator subject to logarithmic transformation can substitute therefor.

In equation (4), the probability of the response variable being a certain value is given as the argument of function F. However, an expectation value of the response variable can be used as the argument of function F.

The constraints of the sixth embodiment can be set for each of all coefficients. It is possible to set any of the above first to fourth constraints or other constraints for each coefficient. Alternatively, when plural coefficients have the same set of possible values, a single constraint can be set for the plural coefficients. In any case, it is only necessary that a set of possible values for plural coefficients be determined.

The sign conditions can be stored in a storage device installed inside or outside the variable selecting apparatus 1 as well as in the auxiliary storage device 56. The same applies to the model building data, the constraints, and the narrow-down conditions. The model building data, the sign conditions, the constraints, and the narrow-down conditions can be stored in the same storage device or distributedly in plural storage devices.

The record acquisition unit 10 may be omitted, insofar as the estimation unit 40 can find an estimate using plural data including realizations of plural candidate explanatory variables and realizations of a response value.

In the fourth and fifth embodiments, either, or both of, the estimation with a constraint and a narrow-down processing with narrow-down conditions, can be further added.

The embodiments discussed in this specification encompass aspects of a method and computer program besides the apparatus.

The present invention is applicable to statistical models in a broader sense, which can be represented by a linear predictor, without being limited to the generalized linear model.

The present invention is described based on the embodiments but is not limited thereto. The present invention allows various modifications and changes made on the basis of technical ideas of the invention.

### LIST OF REFERENCE SYMBOLS

1 variable selecting apparatus

10 record acquisition unit

20 sign condition acquisition unit

30 estimation unit

40 selection unit

51 CPU

52 interface device

53 display device

54 input device

55 drive device

56 auxiliary storage device

57 memory device

58 bus

59 recording medium

1. An apparatus for selecting desired explanatory variables from a plurality of candidate explanatory variables in a statistical model that expresses, by a predetermined function, a relationship between a linear predictor and an expectation value of a response variable or a probability of the response variable having certain values, by using a variable selecting model that expresses the linear predictor as a sum of a constant and a linear combination of the candidate explanatory variables and their corresponding coefficients,
the apparatus comprising:
a constraint acquisition unit for acquiring a constraint that defines a set of possible values for each of the coefficients, the set of possible values for at least one of the coefficients including zero as an isolated point and also including an element other than zero;
an estimation unit for calculating an estimate of the respective coefficients and an estimate of the constant under the constraint, using a plurality of data inclusive of realizations of the respective candidate explanatory variables and realizations of the response variable; and
a selection unit for selecting, as the desired explanatory variables, the candidate explanatory variables corresponding to each of the coefficients of which the estimate is calculated to be non-zero.

2. An apparatus for selecting desired explanatory variables from a plurality of candidate explanatory variables in a statistical model that expresses, by a predetermined function, a relationship between a plurality of linear predictors and an expectation value of a response variable or a probability of the response variable having certain values, by using a variable selecting model that expresses at least one of the linear predictors as a sum of a constant and a linear combination of the candidate explanatory variables and their corresponding coefficients,
the apparatus comprising:
a constraint acquisition unit for acquiring a constraint that defines a set of possible values for each of the coefficients, the set of possible values for at least one of the coefficients including zero as an isolated point and also including an element other than zero;
an estimation unit for calculating an estimate of the respective coefficients and an estimate of the constant under the constraint, using a plurality of data inclusive of an realizations of the respective candidate explanatory variables and an realizations of the response variable; and
a selection unit for selecting, as the desired explanatory variable, the candidate explanatory variable corresponding to each of the coefficient of which the estimate is calculated to be non-zero.

3. The apparatus according to claim 1, wherein the estimation unit determines, as the estimates, values of the coefficients and constant which maximize a likelihood function of the variable selecting model under the constraint.

4. The apparatus according to claim 1, further comprising, when the selection unit selects two or more of the explanatory variables,
a narrow-down condition acquisition unit for acquiring predetermined narrow-down conditions used to narrow down the selected explanatory variables, and
a narrow-down processing unit for narrowing down the explanatory variables based on the narrow-down conditions.

5. A method for selecting desired explanatory variables from a plurality of candidate explanatory variables in a statistical model that expresses, by a predetermined function, a relationship between a linear predictor and an expectation value of a response variable or a probability of the response variable having certain values, by using a variable selecting model that expresses the linear predictor as a sum of a constant and a linear combination of the candidate explanatory variables and their corresponding coefficients,
the method being performed by an apparatus comprising a constraint acquisition unit, an estimation unit, and a selection unit,
the method comprising:
a constraint acquisition step for acquiring, by the constraint acquisition unit, a constraint that defines a set of possible values for each of the coefficients, the set of possible values for at least one of the coefficients including zero as an isolated point and also including an element other than zero;
an estimation step for calculating, by the estimation unit, an estimate of the respective coefficients and an estimate of the constant under the constraint, using a plurality of data inclusive of realizations of the respective candidate explanatory variables and realizations of the response variable; and
a selection step for selecting, as the desired explanatory variable, the candidate explanatory variable corresponding to the coefficient of which the estimate is calculated to be non-zero, by the selection unit.

6. A method for selecting desired explanatory variables from a plurality of candidate explanatory variables in a statistical model that expresses, by a predetermined function, a relationship between a plurality of linear predictors and an expectation value of a response variable or a probability of the response variable having certain values, by using a variable selecting model that expresses at least one of the linear predictors as a sum of a constant and a linear combination of the candidate explanatory variables and their corresponding coefficients,
the method being performed by an apparatus comprising a constraint acquisition unit, an estimation unit, and a selection unit,
the method comprising:
a constraint acquisition step for acquiring, by the constraint acquisition unit, a constraint that defines a set of possible values for each of the coefficients, the set of possible values for at least one of the coefficients including zero as an isolated point and also including an element other than zero;
an estimation step for calculating, by the estimation unit, an estimate of the respective coefficients and an estimate of the constant under the constraint, using a plurality of data inclusive of realizations of the respective candidate explanatory variables and realizations of the response variable; and
a selection step for selecting, as the desired explanatory variable, the candidate explanatory variable corresponding to the coefficient of which the estimate is calculated to be non-zero, by the selection unit.

7. The method according to claim 5, wherein the estimation step comprises a step of determining, as the estimates, values of the coefficients and constant which maximize a likelihood function of the variable selecting model under the constraint.

8. The method according to claim 5, wherein the apparatus further comprises a narrow-down condition acquisition unit and a narrow-down processing unit, and
the method further comprises, when two or more of the explanatory variables are selected in the selection step,
a narrow-down condition acquisition step for acquiring, by the narrow-down condition acquisition unit, predetermined narrow-down conditions used to narrow down the selected explanatory variables, and
a narrow-down processing step for narrowing down, by the narrow-down processing unit, the explanatory variables based on the narrow-down conditions.

9. A program for selecting desired explanatory variables from a plurality of candidate explanatory variables in a statistical model that expresses, by a predetermined function, a relationship between a linear predictor and an expectation value of a response variable or a probability of the response variable having certain values, by using a variable selecting model that expresses the linear predictor as a sum of a constant and a linear combination of the candidate explanatory variables and their corresponding coefficients,
the program causing a computer to execute:
a constraint acquisition step for acquiring a constraint that defines a set of possible values for each of the coefficients, the set of possible values for at least one of the coefficients including zero as an isolated point and also including an element other than zero;
an estimation step for calculating an estimate of the respective coefficients and an estimate of the constant under the constraint, using a plurality of data inclusive of realizations of the respective candidate explanatory variables and realizations of the response variable; and
a selection step for selecting, as the desired explanatory variable, the candidate explanatory variable corresponding to the coefficient of which the estimate is calculated to be non-zero.

10. A program for selecting desired explanatory variables from a plurality of candidate explanatory variables in a statistical model that expresses, by a predetermined function, a relationship between a plurality of linear predictors and an expectation value of a response variable or a probability of the response variable having certain values, by using a variable selecting model that expresses at least one of the linear predictors as a sum of a constant and a linear combination of the candidate explanatory variables and their corresponding coefficients,
the program causing a computer to execute:
a constraint acquisition step for acquiring a constraint that defines a set of possible values for each of the coefficients, the set of possible values for at least one of the coefficients including zero as an isolated point and also including an element other than zero;
an estimation step for calculating an estimate of the respective coefficients and an estimate of the constant under the constraint, using a plurality of data inclusive of realizations of the respective candidate explanatory variables and realizations of the response variable; and
a selection step for selecting, as the desired explanatory variable, the candidate explanatory variable corresponding to the coefficient of which the estimate is calculated to be non-zero.

11. The program according to claim 9, wherein the estimation step comprises a step of determining, as the estimates, values of the coefficients and constant which maximize a likelihood function of the variable selecting model under the constraint.

12. The program according to claim 9, further comprising, when two or more of the explanatory variables are selected in the selection step,
a narrow-down condition acquisition step for acquiring predetermined narrow-down conditions used to narrow down the selected explanatory variables, and
a narrow-down processing step for narrowing down the explanatory variables based on the narrow-down conditions.
